(19) United States
(12) Patent Application Publication
(10) Pub. No.: US 2011/0153768 A1
(43) Pub. Date: Jun. 23, 2011

(54) E-MEETING PRESENTATION RELEVANCE ALERTS

(75) Inventors: BERNADETTE A. CARTER, CARY, NC (US); ARTHUR R. FRANCIS, RALEIGH, NC (US)

(73) Assignee: INTERNATIONAL BUSINESS MACHINES CORPORATION, ARMONK, NY (US)

(21) Appl. No.: 12/645,974

(22) Filed: Dec. 23, 2009

(51) Int. Cl. G06F 15/16

(52) U.S. Cl. 709/207

(57) ABSTRACT

Electronic meeting relevance alerts that include receiving, by a processing device, metadata related to an electronic meeting, comparing, by the processing device, the metadata with preferences of an attendee invited to the electronic meeting to determine a relevancy of the metadata to the attendee, and sending, by the processing device, a notification to the attendee responsive to the relevancy of the metadata to the attendee.

### BACKGROUND

Aspects of the present invention relate to electronic meetings, and more specifically to electronic meeting presentation relevance alerts.

Whenever there is a slide presentation in a web conference with a large number of participants, all slides normally do not garner the same amount of interest from all participants. An attendee's interest in a slide tends to be based upon the topic and corresponding points. The slides are also useful for knowing what the speaker is talking about if an attendee's attention has been diverted. Unfortunately in today's web conference or e-meeting environments (e.g., IBM Lotus Sametime Unyte) a user must pay attention to an entire presentation, even if he is only interested in a specific section unless the speaker gives some clue as to what time each topic will be presented. In addition, when there are a large number of participants, it is not feasible for the presenter to tell each person when the most relevant part for him will be presented. Therefore, the attendee must actively listen to the web conference if he is unable to allow the web conference to retain focus for the entire session on his terminal because he needs to multi-task. Many times there are multiple meetings taking place at the same time and the attendee is only interested in a small subsection of each meeting. While it is possible to attend multiple e-meetings at once, it is not practical to be able to keep track of what is going on in each one and there is a high likelihood of missing the desired information.

### BRIEF SUMMARY

According to one aspect of the present invention, a method, operable on a processing device, for electronic meeting relevance alerts that includes receiving, by the processing device, metadata related to an electronic meeting, comparing, by the processing device, the metadata with preferences of an attendee invited to the electronic meeting to determine a relevancy of the metadata to the attendee, and sending, by the processing device, a notification to the attendee responsive to the relevancy of the metadata to the attendee.

According to another aspect of the present invention, a processing device for electronic meeting relevance alerts includes a network interface, the network interface being configured to receive metadata related to an electronic meeting, and a processor, the processor configured to compare the metadata with preferences of an attendee invited to the electronic meeting to determine a relevancy of the metadata to the attendee, and to send a notification to the attendee responsive to the relevancy of the metadata to the attendee.

According to a further aspect of the present invention, a computer program product comprising a computer readable storage medium having computer readable program code embodied therewith, the computer readable storage medium including computer readable program code configured to receive metadata related to an electronic meeting, computer readable program code configured to compare the metadata with preferences of an attendee invited to the electronic meeting to determine a relevancy of the metadata to the attendee, and computer readable program code configured to send a notification to the attendee responsive to the relevancy of the metadata to the attendee.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for electronic meeting relevance alerts according to an exemplary embodiment of the present invention;

FIG. 2 is a flowchart of a process for electronic meeting relevance alerts according to an exemplary embodiment of the present invention;

FIG. 3 is a flowchart of a process for electronic meeting relevance alerts according to another exemplary embodiment of the present invention; and

FIG. 4 is a flowchart of a process for electronic meeting relevance alerts according to a still further exemplary embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments according to the present invention alert a meeting attendee when a slide, demo, or any other portion of a web conference that is most relevant to him is being presented in order to enable the attendee to more efficiently multi-task if desired. In embodiments according to the present invention, an electronic meeting may be, for example, an electronic conference, a web conference, an electronic presentation, a meeting, conference or presentation that may be accessed remotely, a meeting occurring in a virtual world, etc.

Embodiments according to the present invention may include a feature enhancement to existing web conference software that may send alerts to meeting attendees based upon the perceived relevance of the slide or actions that are occurring. This perceived relevance may be determined by analyzing the data attained from the presented content, shared application metadata, or actions occurring on the presenter's system. This data may be compared with the interests of each meeting attendee and if a specific relevancy threshold has been met, then an alert is provided to the user. The alert may be audio, visual, tactile, or any other type of alert. A user or a server may define keywords, each with a relevancy rating for the user in a profile. The user or server may also define a specific relevancy threshold that may determine whether an alert is sent to the user when a comparison occurs. The comparison and relevancy may also be determined at a user's device, in which case, the alerts may be generated locally at the user's device. The user may be physically present at the meeting or remote from the meeting and each case, receive alerts based on the comparison and relevancy of the content of the meeting.

If a user is attending multiple web conferences (e.g., by way of logging in via a laptop, portable device, workstation, etc.), then the system may switch which web conference has a primary focus (e.g., larger window on a display) based upon perceived relevance to the user. If the web conferencing system is using VoIP, then the corresponding audio may be automatically switched to the appropriate web conference. The web conference may also provide a graphical representation of the perceived relevance of each section of the presentation if the shared application is able to provide all of the metadata to the web conference server at the beginning of the meeting.

The relevancy of a slide or presentation section to a user may be determined by any of many different methods such as, for example, from content retrieved from the displayed application or actions occurring on the presenter's machine, from preferences of the meeting attendee, passively (e.g., from keywords set by the system in a user's profile that occur in the presentation or actions), etc. Actions may include, for example, a presenter switching applications, performing certain actions on an application, etc.

Regarding content being retrieved from the displayed application or actions occurring on the presenter's machine, consider the following examples to help illustrate embodiments of the present invention. In a first example: if a presenter is giving a slide presentation, then the presenter may tag certain slides with keywords to aid in relevancy determination. The presenter may also tag a slide with specific people that he thinks should pay the most attention or possibly even chime in or tag a slide with characteristics or interests of people for providing relevant alerts. This is one example of the metadata that the presenter may provide while preparing his presentation. When the presentation is broadcasted on the web conference, then the presentation software may send the broadcasted data to the web conference server. In a second example: the presenter switches applications being displayed from presentation software to a browser or another type of application, which may be the result of an upcoming demo. This action may be used to determine relevancy of this section of the presentation.

Regarding the preferences of the meeting attendee consider the following example. A meeting attendee may setup a profile of interests with the web conference system or for a specific meeting add keywords or actions that he would like to be made aware of. For example, if a person is at or connected to an “All-Hands” meeting (i.e., all employees are invited to attend), the person may desire to be made aware of when a slide comes up that has a product related to or of interest to the person (e.g. a product or product line the person manages or sells).

Regarding relevancy being determined passively, the preferences for interested topics may come from a profile constructed from data such as social network information, organization charts, social bookmark tagging, etc. The preferences may also be based upon what an invitee's close connections have selected to determine relevancy.

Therefore, embodiments according to the present invention may be configured to provide a user with the ability to multi-task if desired and still know when desired portions of a presentation are being displayed. In addition, a user is no longer forced to look at the presentation in order to know when a slide of importance to the user is being displayed. For example, with the popularity of mobile devices (e.g., phones, personal digital assistants (PDAs), smart phones, portable computing device, laptops, etc.), a user may not be in front of a desktop computer and may only be listening in to a presentation, but has at least some ability to view the presentation on his mobile device. The user being mobile may not allow watching the entire presentation on his phone because the mobile device may need to remain in his pocket. However, if a slide of importance to the user is being displayed the user may desire to be made aware.

Therefore, according to embodiments of the present invention, as a user is listening to the presentation, the mobile device may vibrate, provide an audio or visual signal or any combination of these when a slide or portion of the presentation of relevance to the user is being displayed. This may also be helpful for users who are not actively listening to the meeting because it alerts them of an important section. Embodiments according to the present invention further allows for a personalized meeting experience for each meeting attendee such that the meeting attendee knows when the most interesting parts of the presentation to the attendee are being presented.

Embodiments according to the present invention may include a web conference application plug-in that captures data being displayed by presentation software at a presentation/conference as well as capture additional metadata from the presentation software being shared on the presenter's machine. The metadata may consist of information about the web conference software, which may range from presentation applications such as, for example, IBM Lotus Symphony, Microsoft PowerPoint, or a demo of any type of software. IBM and Lotus Symphony are trademarks of International Business Machines Corporation in the United States, other countries or both. Microsoft and PowerPoint are trademarks of the Microsoft Corporation in the United States, other countries or both.

According to embodiments of the present application, presentation software may have a web conference plug-in installed that allows a presenter during a presentation preparation phase to add keyword tagging, traits or characteristics of potential interested users, and/or the name of users who should be notified for a specific slide or section. The content slide data itself may also be metadata that is used by the web conference plug-in. When the presenter is using presentation software to share information and perform various actions such as changing the slide or invoking a slide animation, metadata corresponding to the shared information may be sent to a web conference server. The web conference server may compare the metadata with the profiles and preferences of each of the attendees and send desired notifications to attendees based upon a relevancy rating of the metadata to each attendee. This comparison may also be done on a client side if desired by forwarding the metadata to the attendees' machines.

User profiles may have been constructed either actively or passively. For example, an active process may include a user setting up a profile for a particular meeting to cause alerts to be generated based on keywords or actions in a presentation or actions in a presentation. A passive process may include a system or presenter creating one or more profiles based on keywords in a presentation or actions in a presentation. The entire presentation may consist of metadata where a server may compare keywords in the metadata with keywords in the one or more profiles and send alerts based on the comparisons. An alert may be presented to an invitee in the form of a screen shot of a portion of a presentation, text, multimedia, a link to the presentation/electronic conference, etc. The invitee/user may define what type of alert is desired. This may be defined in a profile or otherwise.

According to embodiments of the present invention, a meeting/presentation attendee may receive an alert if a relevancy threshold has been met or exceeded and/or desired actions have occurred on the presenter's machine such as a displayed application has changed. The alert may be audio, visual, or tactile. According to embodiments of the present invention, a user may be remotely attending (e.g., logged into) multiple electronic presentations or meetings. The user may receive alerts from each of these multiple electronic presentations/meetings and switch to an appropriate video and/or audio of a presentation/meeting when an alert is received. If desired by the attendee, the corresponding electronic meeting may also be brought to the forefront of a display of the attendee, and corresponding audio (e.g., Voice over Internet Protocol (VoIP)) switched to that web conference if the user is attending multiple meetings at once. Alternatively, the user may view a visual portion of a presentation of one electronic meeting while listening to an audio of another electronic meeting. A server may perform switching of video and/or audio data of multiple electronic meetings being sent or presented to a user connected to multiple electronic meetings based on a relevancy of what is currently occurring in each electronic meeting or based on a relevancy of each electronic meeting. The server may determine the relevancy and switch the video and/or audio data being sent to the user based on the relevancy.

Moreover, according to embodiments of the present invention, a user may not be connected to, logged into, or otherwise attending an electronic conference/presentation/meeting and still be sent an alert when information or actions relevant to the user or of interest to the user is about to be (or is currently) presented or occurring. In this regard, the user may then log into the corresponding conference/presentation/meeting or click a displayed link to be connected.

In addition, according to embodiments of the present invention, a user may receive an alert from a server regarding relevant information in an electronic conference/meeting and provide feedback to the server regarding whether the alert is acceptable or should be changed. The server may then change future alerts to the user based on the feedback.

According to embodiments of the present invention, alerts may be triggered by any of many potential actions. For example, a slide change by a presenter may trigger an alert to one or more users/attendees. Further, if a slide with content relevant to an attendee/user, based on a keyword match or other matching with a constructed user profile, has been displayed or is about to be displayed an alert to the user/attendee may be triggered. In addition, according to embodiments of the present invention, a presenter may add additional metadata referencing one or more attendees as interested parties, and an alert to the one or more users/attendees may be triggered based on presentation metadata matches with the attendees' metadata.

Moreover, according to embodiments of the present invention, another attendee may recommend a particular slide to an attendee and an alert triggered accordingly. Also, when a shared application has changed (potential demo about to start) a triggered event may be generated that sends an alert. Further, when a shared application goes into a certain state, a triggered event may be generated that sends an alert. Still further, a triggered event may be generated that sends an alert when other users who a user is socially connected, or are the user's superiors or a user's reports in the user's organization are being alerted for a particular slide or portion of a presentation.

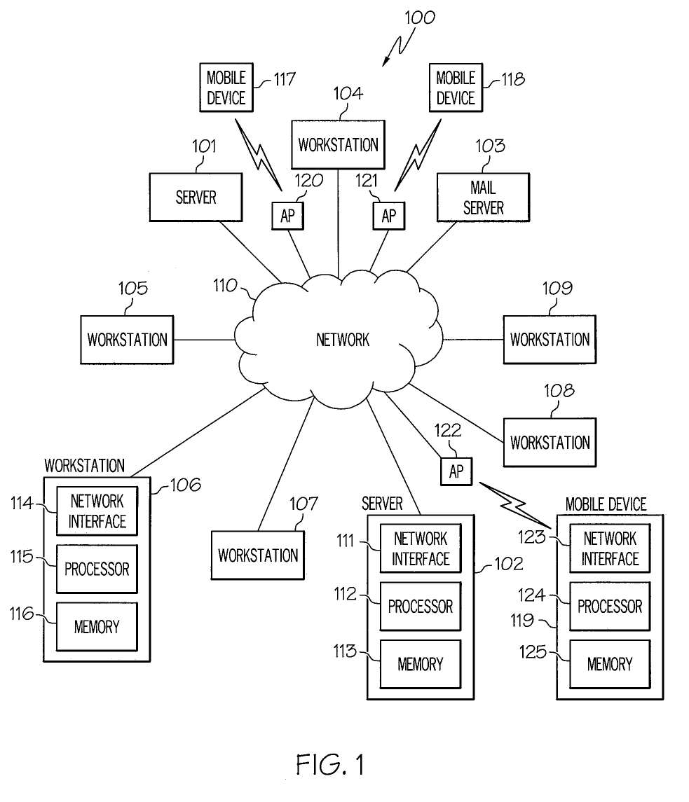

FIG. 1 shows a diagram of a system for electronic meeting relevance alerts according to an exemplary embodiment of the present invention. A system 100 may include one or more servers 101, 102, one or more mail servers 103, one or more wireless devices 117-119, and one or more workstations 104-109, where the servers 101, 102, wireless devices 117-119, and workstations 104-109 may be interconnected via a network 110. The one or more mail servers 103 may be used for either alerts or to retrieve additional information about a user's interest, expertise, or people connections. The wireless devices 117-119 may access the network 110 via one or more access points 120-122 or by any other method. The wireless devices 117-119 may be any type of wireless device such as, for example, a mobile phone, a personal digital assistant (PDA), a portable game system, a laptop computer, etc. The network 110 may be the Internet, an intranet, a local area network, a wide area network, or any other type of network. Each server 101, 102, 103 may include a network interface 111, a processor 112, a memory 113, and other elements normally associated with a server. Similarly, each workstation 104-109 may include a network interface 114, a processor 115, and memory 116, and other items normally associated with a workstation. A processor 112 of each server 101, 102 or a processor 115 of each workstation 104-109 may execute software and/or be configured to compare metadata with at least one of profiles and preferences of an attendee invited to an electronic meeting and send notifications to the attendee responsive to the comparison and a relevancy of the metadata to the attendee. The preferences may be a profile of interests of the attendee, keywords of interest to the attendee, and/or actions of interest to the attendee.

A network interface 111 of each server 101-103, a network interface 114 of each workstation 104-109, or a network interface 123 of each mobile device 117-119 may be configured to receive metadata related to an electronic meeting. A processor 112 of each server 101-103, a processor 115 of each workstation 104-109, or a processor 124 of each mobile device 117-119 may be configured to switch between at least one of video and audio data of multiple electronic meetings being sent to a user connected to the multiple electronic meetings. A processor 112 of each server 101-103 or a processor 115 of each workstation 104-109, or a processor 124 of each mobile device 117-119 may be configured to switch between the at least one of video and audio data of multiple electronic meetings being sent to a user based on a relevancy of what is currently occurring in each electronic meeting. A processor 112 of each server 101-103, a processor 115 of each workstation 104-109, or a processor 124 of each mobile device 117-119 may also be configured to switch between the at least one of video and audio data of multiple electronic meetings being sent to a user based on a relevancy of each electronic meeting. A processor 112 of each server 101-103 or a processor 115 of each workstation 104-109 may further be configured to send the notifications to the mobile device 117-119 of the attendee. Each mobile device 117-119 may also include a memory 125. The notification may include a video alert, an audio alert, and/or a tactile alert or a combination of any of these.

Moreover, according to embodiments of the present invention, a processor 112 of each server 101-103, a processor 115 of each workstation 104-109, or a processor 124 of each mobile device 117-119 may be configured to receive the preferences of the attendee. A processor 112 of each server 101-103, a processor 115 of each workstation 104-109, or a processor 124 of each mobile device 117-119 may be configured to receive data for profiles and preferences of an attendee invited to an electronic conference from sources other than the attendee. A processor 112 of each server 101-103, a processor 115 of each workstation 104-109, or a processor 124 for each mobile station 117-119 may also be configured to access a social network, an organizational chart, a social bookmark tag service or other such service or system. Data from any services or systems such as these may be used or leveraged to provide additional insight into a user and the user's connections with people and/or specific types of data. In other words, anything that may be used to determine a user's interests, current state (contextual information, such as location, etc.) or expertise and construct a profile for the attendee from data from the social network, the organizational chart, the social bookmark tag, another user insight aiding service or system, etc.

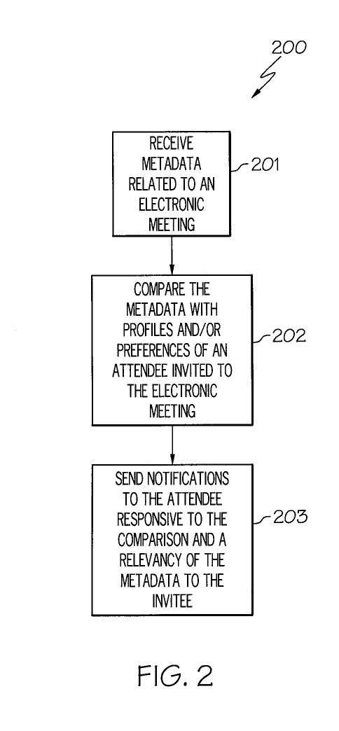

FIG. 2 shows a flowchart of a process for electronic meeting relevance alerts according to an exemplary embodiment of the present invention. In the process 200 in block 201, metadata related to an electronic meeting may be received. In block 202, the metadata may be compared with profiles and/or preferences of an attendee invited to the electronic meeting. In block 203, notifications may be sent to the attendee responsive to the comparison and a relevancy of the metadata to the invitee.

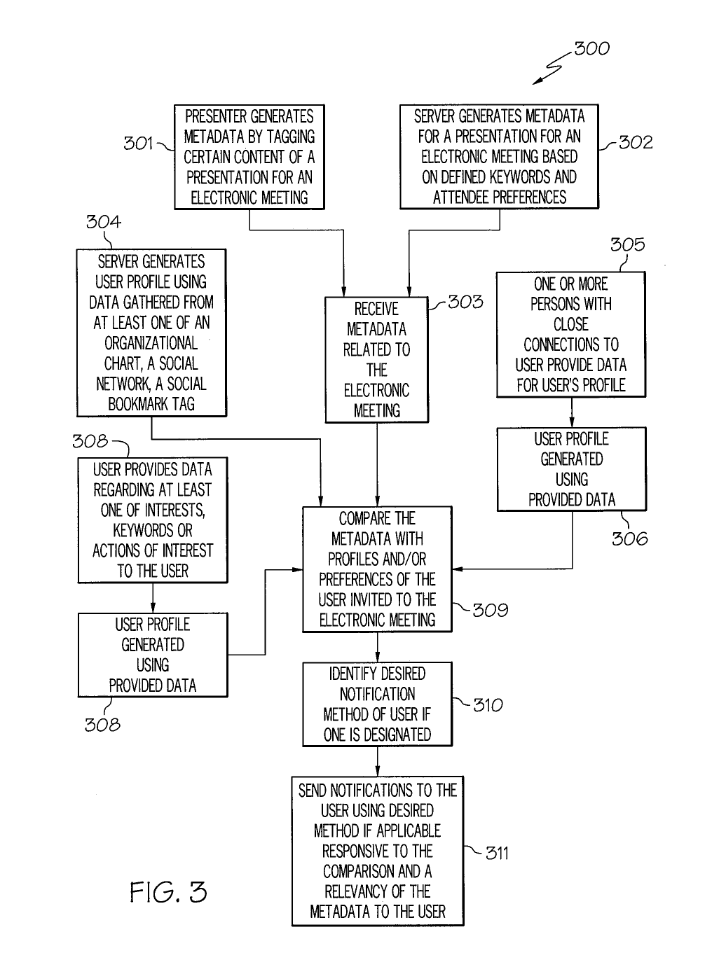

FIG. 3 shows a flowchart of a process for electronic meeting relevance alerts according to another exemplary embodiment of the present invention. In the process 300, in block 301, a presenter may generate metadata by tagging certain content of a presentation for an electronic meeting. In block 302, a server may generate metadata for a presentation for an electronic meeting based on defined keywords and attendee preferences. In block 303, the metadata related to the electronic meeting may be received. In block 304, a server may generate a user profile using data gathered from an organizational chart, a social network, a social bookmark tag or similar service or system and may leverage data from any such service or system to provide additional insight into the user and his connections with people and/or specific data. In block 305, one or more persons with close connections to the user may provide data for a user's profile. In block 306, a user profile may be generated using the provided data. In block 307, a user may provide data regarding interests, keywords and/or actions of interest to the user. In block 308, a user profile may be generated using the provided data. In block 309, all the metadata may be compared with profiles and/or preferences of the user invited to the electronic meeting. In block 310, a desired notification method of the user may be identified if the user has designated one. In block 311, notifications may be sent to the user using the desired method, if applicable, responsive to the comparison and a relevancy of the metadata to the user. A type of alert or notification that may be sent may be based on the relevance of the presentation, content type, or environment of the user.

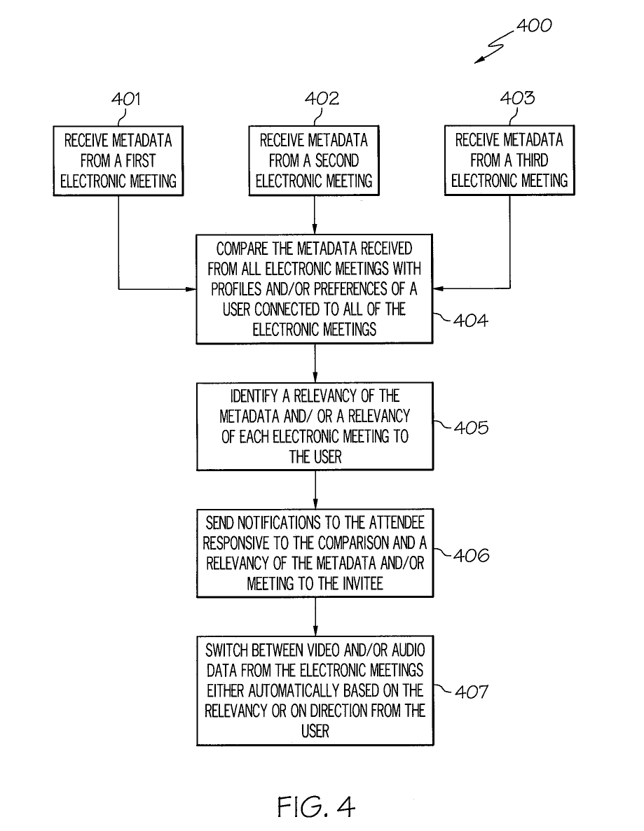

FIG. 4 shows a flowchart of a process for electronic meeting relevance alerts according to a still further exemplary embodiment of the present invention. A user may be connected to multiple electronic meetings. In this exemplary embodiment, a user is connected to three electronic meetings however, embodiments of the present invention are not limited to three as a user may be connected to any number of electronic meetings and still be within the scope of the present invention. In the process 400, in block 401, metadata may be received from a first electronic meeting. In block 402, metadata may be received from a second electronic meeting. In block 403, metadata may be received from a third electronic meeting. In block 404, the metadata received from all electronic meetings may be compared with profiles and/or preferences of a user connected to all of the electronic meetings. In block 405, a relevancy of the metadata and/or a relevancy of each electronic meeting to the user may be identified. In block 406, notifications may be sent to the attendee responsive to the comparison and a relevancy of the metadata and/or meeting to the invitee. In block 407, switching may occur between video and/or audio data from the electronic meetings either automatically based on the relevancy or on direction from the user.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method, operable on a processing device, for electronic meeting relevance alerts comprising:
receiving, by the processing device, metadata related to an electronic meeting;
comparing, by the processing device, the metadata with preferences of an attendee invited to the electronic meeting to determine a relevancy of the metadata to the attendee; and
sending, by the processing device, a notification to the attendee responsive to the relevancy of the metadata to the attendee.

2. The method according to claim 1, further comprising receiving, by the processing device, the preferences of the attendee.

3. The method according to claim 1, wherein the preferences comprise at least one of a profile of interests of the attendee, keywords of interest to the attendee, and actions of interest to the attendee.

4. The method according to claim 3, further comprising the processing device accessing at least one of a social network, an organizational chart, a social bookmark tag service, and any other service and system useable to provide insight into the attendee's connections with people and specific types of data, and constructing the profile of interest of the attendee from data from the at least one of the social network, the organizational chart, the social bookmark tag, and any other service or system useable to provide insight into the attendee's connections with people and specific types of data, and taking into consideration any contextual information from an attendee's access device for accessing the electronic meeting.

5. The method according to claim 1, further comprising receiving, by the processing device, data for the at least one of profiles and preferences of the attendee invited to the electronic conference from sources other than the attendee.

6. The method according to claim 5, wherein the other sources comprises a person with close connections to the attendee.

7. The method according to claim 1, further comprising the processing device sending the notification to a mobile device of the attendee.

8. The method according to claim 1, wherein the notification comprises at least one of a video alert, an audio alert, and a tactile alert.

9. The method according to claim 1, further comprising the processing device switching between at least one of video and audio data of multiple electronic meetings being sent to a user connected to the multiple electronic meetings.

10. The method according to claim 9, further comprising the processing device switching between the at least one of video and audio data of multiple electronic meetings being sent to a user based on a relevancy of what is currently occurring in each electronic meeting.

11. The method according to claim 9, further comprising the processing device switching between the at least one of video and audio data of multiple electronic meetings being sent to a user based on a relevancy of each electronic meeting.

12. A processing device for electronic meeting relevance alerts comprising:
a network interface, the network interface being configured to receive metadata related to an electronic meeting; and
a processor, the processor configured to compare the metadata with preferences of an attendee invited to the electronic meeting to determine a relevancy of the metadata to the attendee, and to send a notification to the attendee responsive to the relevancy of the metadata to the attendee.

13. The processing device according to claim 12, wherein the notification comprises at least one of a video alert, an audio alert, and a tactile alert.

14. The processing device according to claim 12, further comprising the processor switching between at least one of video and audio data of multiple electronic meetings being sent to a user connected to the multiple electronic meetings.

15. The processing device according to claim 14, further comprising the processor switching between the at least one of video and audio data of multiple electronic meetings being sent to a user based on a relevancy of what is currently occurring in each electronic meeting.

16. The processing device according to claim 14, further comprising the processor switching between the at least one of video and audio data of multiple electronic meetings being sent to a user based on a relevancy of each electronic meeting.

17. The processing device according to claim 12, wherein the preferences comprise at least one of a profile of interests of the attendee, keywords of interest to the attendee, and actions of interest to the attendee.

18. The processing device according to claim 12, further comprising the processor sending the notification to a mobile device of the attendee.

19. A computer program product comprising a computer readable storage medium having computer readable program code embodied therewith, the computer readable storage medium comprising:
computer readable program code configured to receive metadata related to an electronic meeting;
computer readable program code configured to compare the metadata with preferences of an attendee invited to the electronic meeting to determine a relevancy of the metadata to the attendee; and
computer readable program code configured to send a notification to the attendee based on the relevancy of the metadata to the attendee.

20. The computer program product according to claim 19, wherein the preferences comprise at least one of a profile of interests of the attendee, keywords of interest to the attendee, and actions of interest to the attendee.
